(19) United States
(12) Patent Application Publication
(10) Pub. No.: US 2016/0271562 A1
(43) Pub. Date: Sep. 22, 2016

(54) REMOVAL OF AMMONIA FROM AMMONIA-CONTAINING WATER USING AN ELECTRODIALYSIS PROCESS

(71) Applicant: SALTWORKS TECHNOLOGIES INC., Richmond (CA)

(72) Inventors: Benjamin Sparrow, Richmond (CA); Xiangchun Yin, Richmond (CA)

(73) Assignee: Saltworks Technologies Inc., Richmond, BC (CA)

(21) Appl. No.: 15/033,999

(22) PCT Filed: Nov. 6, 2014
(86) PCT No.: PCT/CA2014/051072

§ 371 Date: May 3, 2016

Related U.S. Application Data
(60) Provisional application No. 61/901,264, filed on Nov. 7, 2013.

(51) Int. Cl. B01D 61/44; B01D 9/00; C02F 1/20; B01D 61/46; B01D 61/58; C02F 1/469; B01D 19/00; B01D 1/00

(52) U.S. Cl. CPC B01D 61/445; B01D 19/0036; B01D 19/0073; B01D 19/0031; B01D 19/0042; B01D 9/0031; B01D 1/00; B01D 61/46; B01D 61/58; C02F 1/4693; C02F 1/20; B01D 2009/0086; B01D 2311/04; B01D 2311/2653; B01D 2311/2673; B01D 2311/263; C02F 2101/16

(57) ABSTRACT

A process and system for removing ammonia from an aqueous ammonia solution. A first aqueous solution and the ammonia solution are flowed respectively through a first and a second separation chamber of a bipolar membrane electrodialysis (“BPMED”) stack. The first separation chamber is bounded on an anodic side by a cation exchange membrane and the second separation chamber is bounded on a cathodic side by the cation exchange membrane and on an anodic side by a bipolar membrane. The bipolar membrane has an anion-permeable layer and a cation-permeable layer respectively oriented to face the stack's anode and cathode. While the solutions are flowing through the stack a voltage is applied across the stack that causes the bipolar membrane to dissociate water into protons and hydroxide ions. The protons migrate into the second separation chamber and react there with ammonia to form ammonium ions that migrate to the first separation chamber.

### TECHNICAL FIELD

The present disclosure is directed at processes, systems, and techniques for removing ammonia from ammonia-containing water using an electrodialysis process.

### BACKGROUND

“Ammonia-containing water” is water in which ammonia (NH₃) is dissolved. One type of ammonia-containing water is ammonia wastewater, which is harmful to the environment and should be treated prior to being discharged into the environment. Presently, ammonia wastewater is mainly treated first by using biological processes to convert the ammonia into nitrate, and then by putting the wastewater through a denitrification process. The treatment process is expensive and can be prejudiced by seasonal temperature variations.

Examples of conventional processes of capturing ammonia from ammonia wastewater are thermal processes, vacuum stripping, streaming stripping, ion exchange processes, and membrane degassing processes. However, because of the low (<2,000 ppm) concentration of ammonia typical of ammonia wastewater, it is currently not economical to capture ammonia directly from the wastewater by processing large volumes of wastewater using these conventional ammonia-recovery processes.

It would be beneficial to have a lower cost process to remove ammonia from ammonia-containing water such as ammonia wastewater and to recover it as a valuable product.

### SUMMARY

According to a first aspect, there is provided a process for removing ammonia from an aqueous ammonia solution. The process comprises flowing a first aqueous solution and the ammonia solution respectively through a first and a second separation chamber of a bipolar membrane electrodialysis (“BPMED”) stack, wherein the first separation chamber is bounded on an anodic side by a cation exchange membrane and wherein the second separation chamber is bounded on a cathodic side by the cation exchange membrane and on an anodic side by a bipolar membrane, the bipolar membrane comprising an anion-permeable layer and a cation-permeable layer respectively oriented to face an anode and a cathode of the BPMED stack; and applying a voltage across the BPMED stack that causes a direct current to be passed across the bipolar membrane thereby causing the bipolar membrane to dissociate water into protons and hydroxide ions, wherein (i) the protons migrate into the second separation chamber; and (ii) the protons react with ammonia comprising the ammonia solution in the second separation chamber to form ammonium ions that migrate from the second separation chamber to the first separation chamber across the cation exchange membrane.

The process may further comprise returning the ammonia solution exiting the second separation chamber (“ammonia-reduced solution”) to the second separation chamber to remove more of the ammonia therefrom.

The first separation chamber may be bounded on a cathodic side by an additional bipolar membrane comprising an anion-permeable layer and a cation-permeable layer respectively oriented to face the anode and the cathode, and a direct current may also be passed across the additional bipolar membrane thereby causing the bipolar membrane to dissociate water into protons and hydroxide ions, wherein the hydroxide ions migrate into the first separation chamber and react with the ammonium ions react to generate ammonia in the first separation chamber.

The process may further comprise returning the solution that exits the first separation chamber (“concentrated ammonia solution”) to the first separation chamber to further concentrate the ammonia therein.

The process may further comprise recovering gaseous ammonia from the concentrated ammonia solution.

The first separation chamber may be bounded on a cathodic side by an anion exchange membrane and the BPMED stack may further comprise a third separation chamber bounded on an anodic side by the anion exchange membrane and on a cathodic side by an additional cation exchange membrane; and a fourth separation chamber bounded on an anodic side by the additional cation exchange membrane and on a cathodic side by an additional bipolar membrane comprising an anion-permeable layer and a cation-permeable layer respectively oriented to face the anode and the cathode. The process may also further comprise flowing an aqueous salt solution and an aqueous base solution respectively through the third and fourth separation chambers, wherein the aqueous salt solution comprises M⁺ cations and Xⁿ⁻ anions and the aqueous base solution comprises the M⁺ cations and hydroxide ions. A direct current is passed across the additional bipolar membrane causing the bipolar membrane to dissociate water into protons and hydroxide ions, and the hydroxide ions migrate into the fourth separation chamber. The M⁺ cations migrate from the third separation chamber to the fourth separation chamber across the additional cation exchange membrane and the Xⁿ⁻ anions migrate from the third separation chamber to the first separation chamber across the anion exchange membrane. The ammonium and the Xⁿ⁻ anions comprise an ammonium salt solution in the first separation chamber.

The process may further comprise returning the ammonium salt solution that exits the first separation chamber to the first separation chamber to increase concentration of the ammonium salt solution.

The process may further comprise returning the aqueous base solution that exits the fourth separation chamber to the fourth separation chamber to increase concentration of the base solution.

Some of the aqueous salt solution may exit the third separation chamber, and the aqueous salt solution that exits the third separation chamber may be returned to the third separation chamber for reuse.

The process may further comprise recovering solid ammonium salt from the ammonium salt solution.

According to another aspect, there is provided a system for removing ammonia from an aqueous ammonia solution. The system comprises a bipolar membrane electrodialysis (“BPMED”) stack for receiving a first aqueous solution and the ammonia solution. The BPMED is configured to output an ammonia-reduced solution having a lower concentration of ammonia than the ammonia solution and one of (1) an ammonium salt solution; and (2) a concentrated ammonia solution having a higher concentration of ammonia than the ammonia-reduced solution. The system also comprises a purification subsystem fluidly coupled to the BPMED stack to receive the ammonium salt solution or the concentrated ammonia solution and configured to output solid ammonium salt or ammonia gas.

The BPMED stack may be configured to output the ammonium salt solution and the purification subsystem may be configured to output the solid ammonium salt.

The BPMED stack may comprise a first and a second separation chamber, wherein the second separation chamber is bounded on a cathodic side by a cation exchange membrane and on an anodic side by a bipolar membrane, with the bipolar membrane comprising on an anodic side an anion-permeable layer and on a cathodic side a cation-permeable layer. The first separation chamber may be bounded on an anodic side by the cation exchange membrane and on a cathodic side by an additional bipolar membrane, with the additional bipolar membrane comprising on an anodic side an anion-permeable layer and on a cathodic side a cation-permeable layer.

The purification subsystem may comprise a degassing system. The degassing system may use any one or more of a thermal process, vacuum stripping, streaming stripping, and membrane degassing.

The BPMED stack may be configured to output the concentrated ammonia solution and the purification subsystem may be configured to output the ammonia gas.

The BPMED stack may comprise a first, a second, a third, and a fourth separation chamber, wherein the second separation chamber is bounded on a cathodic side by a cation exchange membrane and on an anodic side by a bipolar membrane, with the bipolar membrane comprising on an anodic side an anion-permeable layer and on a cathodic side a cation-permeable layer. The first separation chamber may be bounded on an anodic side by the cation exchange membrane and on a cathodic side by an anion exchange membrane. The third separation chamber may be bounded on an anodic side by the anion exchange membrane and on a cathodic side by an additional cation exchange membrane. The fourth separation chamber may be bounded on an anodic side by the additional cation exchange membrane and on a cathodic side by an additional bipolar membrane comprising on an anodic side an anion-permeable layer and on a cathodic side a cation-permeable layer.

The purification subsystem may comprise a solid purification system.

The solid purification subsystem may comprise a crystallizer or a thermal evaporator.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a schematic illustrating an ammonia removal and recovery system that includes a bipolar membrane electrodialysis subsystem and bypasses that divert flows around components of the system, according to one embodiment.

FIG. 2 is a schematic illustrating a two-compartment bipolar membrane electrodialysis stack for ammonia removal and recovery that may comprise part of the system of FIG. 1.

FIG. 3 is a schematic illustrating a four-compartment bipolar membrane electrodialysis stack for ammonia removal and recovery that may comprise part of the system of FIG. 1.

### DETAILED DESCRIPTION

The embodiments described herein comprise processes, systems, and techniques for removing ammonia from ammonia-containing water using a bipolar membrane electrodialysis stack (“BPMED stack”). At least some of these embodiments may also be used, for example, to economically recover from ammonia wastewater at least one of a concentrated ammonia solution, a concentrated ammonium salt solution, an ammonia gas, and a solid ammonium salt.

BPMED stacks are electrochemical stacks that include at least one bipolar membrane (“BPM”); the BPM comprises an anion-permeable layer and a cation-permeable layer and is oriented so that the anion-permeable layer faces the stack's anode and the cation-permeable layer faces the stack's cathode. When an ionic current is flowing through the stack and an electrical potential is applied across the stack such that the potential across the BPM equals or exceeds a theoretical water dissociation voltage of 0.83 V, water is dissociated by the BPM into protons (H⁺) and hydroxide ions (OH⁻). As a salt solution flows through a BPMED stack over both sides of the BPM while the BPM is used to dissociate the water, the solution in the cathode-facing (“cathodic”) chamber on the side of cation-permeable layer of the BPM becomes acidified and the solution in the anode-facing (“anodic”) chamber on the side of the anion-permeable layer of the BPM becomes basified. Two separated solution streams leave the BPMED stack: an acidified solution stream and a basified solution stream. A general BPMED stack can have either a two-compartment or a three-compartment configuration. In a two-compartment configuration, adjacent membranes may alternate between a BPM and an anion exchange membrane (“AEM”) to form a “BPM/AEM stack” or adjacent membranes may alternate between a BPM and a cation exchange membrane (“CEM”) to form a “BPM/CEM stack”. In a three-compartment cell, adjacent membranes may cycle from BPM to AEM to CEM, forming a “BPM/AEM/CEM” stack. For any of these configurations, each of the end membranes at the two ends of the BPMED stack may be an AEM, CEM, or BPM, depending on the particular configuration and process conditions.

While acids and bases produced using a BPMED stack may be used to regenerate acidic or basic materials such as ion exchange resins, acid absorbents, and base absorbents, the electrodialytic production of acids and bases using the BPMED stack, especially at concentrations higher concentration than 0.1 mol L⁻¹, is particularly inefficient and uses high amounts of energy.

A two-step process of removing ammonia from ammonia-containing water (interchangeably referred to as an “aqueous ammonia solution”, an “ammonia solution” and “feed water”) and of concentrating and then recovering, for example, the ammonia in gaseous form or an ammonium salt using a bipolar electrodialysis system is described below. As used herein, a “bipolar electrodialysis system” or “BPMED system” is a system that comprises one or more BPMED stacks. Ammonia-containing water is fed directly to a BPMED stack that is used to perform electrodialysis. Electrolysis of the water molecules using one or more BPMs generates H⁺ and OH⁻ ions. The ammonia in the ammonia-containing water first neutralizes acids (the H⁺ ions) generated in the BPMED stack, which converts the ammonia into ammonium ions (NH₄⁺) and then the ammonium ions are concentrated as electrodialysis continues. The concentrated ammonium ions may simultaneously neutralize bases (the OFF ions) produced in the BPMED stack to regenerate ammonia solution or may be recovered directly as a concentrated ammonium salt solution. This two-step process for ammonia removal and recovery reacts ammonia with acids generated in-situ in the BPMED stack to form ammonium ions and then concentrates the ammonium ions simultaneously as electrodialysis progresses. The process uses the acid and the base generated in-situ in the BPMED stack, accordingly resulting in higher current efficiency and requires lower power consumption than conventional processes.

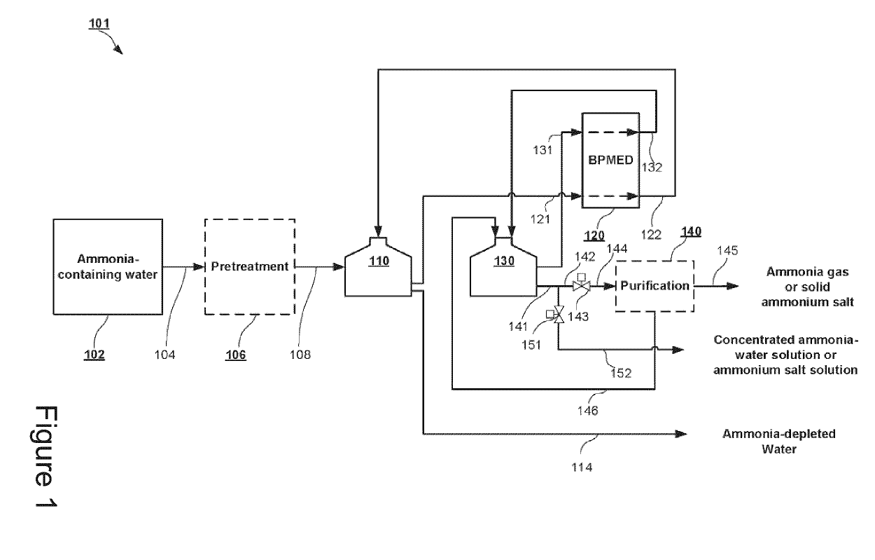

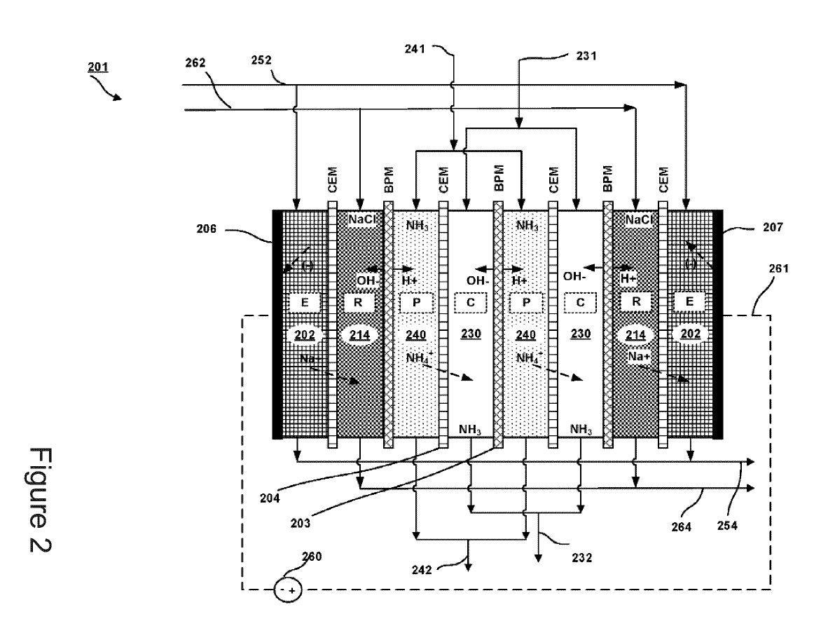

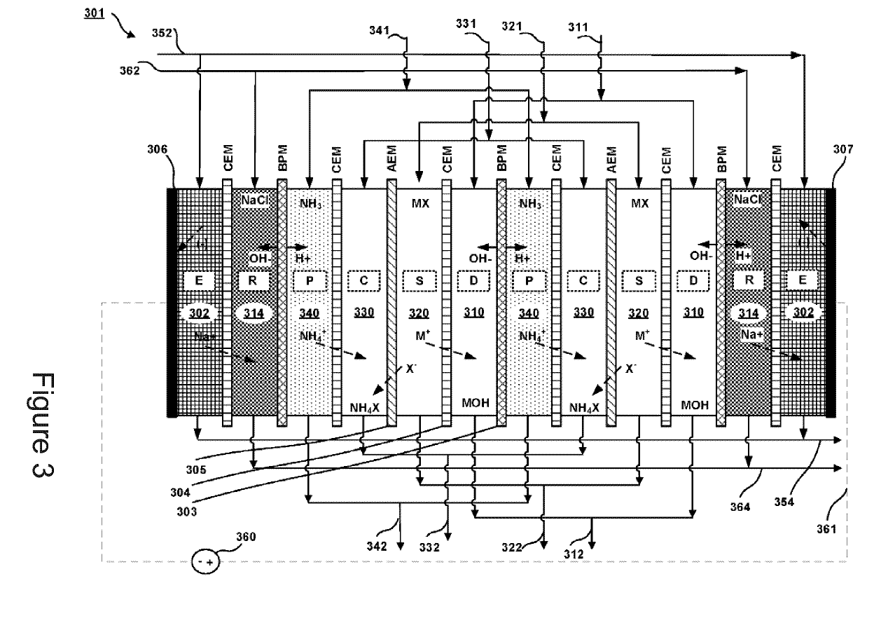

FIG. 1 illustrates an ammonia-removal and recovery system (hereinafter “ammonia-recovery system 101” or simply “system 101”) including a BPMED stack 120. The schematic diagram of the ammonia-recovery system 101 shows the BPMED stack 120, an optional pretreatment subsystem 106, and an optional purification subsystem 140. Embodiments of the BPMED stack 120 and their operations are described in more detail in FIGS. 2 and 3 below. The system 101 is illustrated in a batch-processing mode. However, in an alternative embodiment (not depicted) it may be operated in a “once through” continuous mode by controlling suitable valves, conduits, and pumps. The system 101 may be coupled upstream or downstream of other water-treatment systems to remove and recover ammonia from ammonia-containing wastewater; these other water-treatment systems may employ water-treatment processes such as ion exchange processes, reverse osmosis processes, nanofiltration processes, and thermal evaporation processes.

An ammonia-containing water upon entering the system 101 is supplied along a pretreatment input conduit 104 to the pretreatment subsystem 106, then to a system input conduit 108, then to a first tank 110, then to a first input conduit 121, and then to the BPMED stack 120. The ammonia-containing water may comprise, for example, raw wastewater from fertilizer production or agricultural sources, municipal wastewater, or water containing a certain amount of ammonia after having undergone other water treatments; for example, the ammonia-containing water may be water that has undergone membrane filtrations (i.e., the water may comprise the permeate stream or the rejected stream of a reverse osmosis or nanofiltration process) or the water may comprise the vapor condensate or concentrated brine from a thermal evaporation process. The pretreatment subsystem 106 may use any one or more of the following: settlement and microfiltration to remove suspended solids or precipitates from raw wastewaters; reverse osmosis; nanofiltration; and thermal evaporation.

The BPMED stack 120 reduces the concentration of ammonia in the feed water and accordingly produces an ammonia-reduced stream flowing through a first output conduit 122 to the first tank 110, and an ammonia-concentrated or ammonium salt-concentrated stream flowing through a second output conduit 132 to a second tank 130. Water in the first tank 110 may be recirculated and processed in the BPMED stack 120 until the ammonia content in the first tank 110 is below the ammonia-discharging limit mandated by any applicable environmental regulations. The ammonia-reduced water is then discharged through a first system discharge conduit 114 from the system 101. The second output conduit 132 transfers a concentrated ammonia-water solution when a two-compartment configuration BPMED stack 201 shown in FIG. 2 is used, and transfers a concentrated ammonium salt solution when a four-compartment configuration BPMED stack 301 shown in FIG. 3 is used. The embodiments of the BPMED stack 201,301 shown in FIGS. 2 and 3 are described in more detail below. In order to increase water recovery and to recover ammonia, the ammonia-water solution or ammonium salt solution in the second tank 130 may be concentrated by the BPMED stack 120 to the highest concentration permissible given the operating conditions, and then be recovered from the system 101 via a conduit, a control valve 151, and a second system discharge conduit 152. Alternatively, the ammonia-water solution or ammonium salt solution may be concentrated to a level lower than the highest concentration possible given the operating conditions.

When the two-compartment configuration BPMED stack 201 shown in FIG. 2 is used, ammonia is recovered as a concentrated ammonia-water solution in the second tank 130, and the concentrated ammonia-water solution may be optionally fed through conduits 141,142,144 and a control valve 143 to the optional purification subsystem 140 to recover gaseous ammonia as the final product from the system 101. If recovered, the gaseous ammonia exits the purification subsystem 140 via a third system discharge conduit 145. In this case, the purification subsystem 140 may be any suitable degassing system, such as one that uses any one or more of a thermal process, vacuum stripping, streaming stripping, and membrane degassing.

When the four-compartment configuration BPMED stack 301 shown in FIG. 3 is used, ammonia is recovered as a concentrated ammonium salt solution in the second tank 130, and the concentrated ammonium salt solution may be optionally fed through conduits 141,142,144 and a control valve 143 to the optional purification subsystem 140 to recover solid ammonium salt as the final product via the third system discharge conduit 145. In this case, the optional purification subsystem 140 may be a solid purification system such as a crystallizer or a thermal evaporator. The purification subsystem 140 also produces ammonia-reduced or ammonium salt-decreased water product, which may be recirculated through a conduit 146 to the second tank 130 and be reused for ammonia removal and recovery in the BPMED stack 120.

FIG. 2 shows a schematic of an embodiment of the BPMED stack 201 in a “two-compartment” configuration (this embodiment of the stack 120 is hereinafter interchangeably referred to as a “two-compartment BPMED stack 201”). The recovered product may be a concentrated ammonia-water solution within a first set of separation chambers 230 of the BPMED stack 201. In FIG. 2, a first input conduit 241 may be connected to the first input conduit 121 of FIG. 1 and a second input conduit 231 in FIG. 2 may be connected to the second input conduit 131 of FIG. 1. The feeding stream from the first tank 110 of FIG. 1 is supplied to the two-compartment BPMED stack 120 and a second set of separation chambers 240 through the first input conduit 241. The ammonia-concentrated stream from the second tank 130 in FIG. 1 is supplied to the BPMED stack 120 and the first set of separation chambers 230 through the second input conduit 231. The output of the BPMED stack 120 exits the first set of separation chambers 230 via a second output conduit 232 and the second set of separation chambers 240 via a first output conduit 242. The second output conduit 232 is connected to the second output conduit 132 of FIG. 1 and the first output conduit 242 is connected to the first output conduit 122 of FIG. 1. The recovered product exiting the first set of separation chambers 230 is referred to as being concentrated because as the system 101 is operated the concentration of the ammonia exiting the first set of separation chambers 230 increases and can eventually exceed that of the feeding stream; more generally, references to “concentrated” solutions herein refer to the concentration of a particular solute in that solution increasing as the BPMED stack 120,201,301 is operated.

The two-compartment BPMED stack 201 of FIG. 2 comprises the first and second sets of separation chambers 230,240. Each of the separation chambers 230,240 is bounded on one side by one of a bipolar membrane (BPM) 203 and a cation exchange membrane (CEM) 204 and on another side by the other of the BPM 203 and CEM 204. In the two-compartment BPMED stack 201, adjacent membranes may alternate between BPMs and CEMs to form a membrane stack of the form BPM, CEM, BPM, CEM, etc. A BPM is impermeable to both cations and anions, and splits water into H⁺ and OH⁻ when DC current is applied to the two-compartment BPMED stack 120 (i.e., when ionic current is flowing across membranes within the stack 201) and the potential across the BPM is above a theoretical water dissociation voltage of 0.83 V. The CEMs are permeable to cations while impermeable to anions. Suitable CEMs include, but are not limited to NEOSEPTA CMX™ membranes. Suitable BPMs include, but are not limited to NEOSEPTA BIPOLAR™ membranes.

On each end of the two-compartment BPMED stack 201 are electrolyte chambers 202. A BPM 203 is oriented to the electrodes so that its anion-permeable layer faces the stack's 201 anode 206 and its cation-permeable layer faces the stack's 201 cathode 207. An electrolyte solution is contained in an electrolyte tank (not shown) and pumped by an electrolyte pump (not shown) through an electrolyte distribution conduit 252 into the stack's 201 electrolyte chambers 202. The electrolyte solution flows back into the electrolyte tank in a closed loop process via an electrolyte return conduit 254. Example electrolytes may include, but are not limited to, aqueous sodium sulfate, aqueous potassium nitrate, and other electrolytes known to those skilled in the art. An electric potential (voltage) is applied across the two-compartment BPMED stack 201 by a direct current power supply 260, causing an electric current 261 to flow between the anode 206 and cathode 207, each of which is at one end of the BPMED stack 201. Reduction and oxidation reactions of the electrolyte occur at the cathode 207 and anode 206 respectively, converting the DC electrical current into an ionic current.

Adjacent to the electrolyte chambers 202, and separated from them by the cation exchange membranes 204, are two rinse solution chambers 214; while the rinse solution chambers 214 are shown in FIGS. 2 and 3, they are optional and may be missing from alternative embodiments (not depicted). In the embodiment shown in FIG. 2 the optional rinse solution chambers 214 are separated from the separation chambers 230,240 by the BPMs 203. In other embodiments (not shown), the optional rinse solution chambers 214 may be separated from the chambers 230,240 by two anion exchange membranes such as NEOSEPTA AMX™ membranes. Rinse solution is supplied via a conduit 262 to rinse solution chambers 214 and is removed via a rinse solution return conduit 264. The arrangement of the optional rinse solution chambers 214 in the two-compartment BPMED stack 201 prevents scaling cations such as calcium and magnesium from entering the rinse solution chambers 214 from adjacent separation chambers 230,240. The fact that the rinse solution chambers 214 remain free of calcium and magnesium prevents the passage of calcium and magnesium from entering the electrolyte chambers 202 from the rinse solution chambers 214. The optional rinse solution chambers 214 beneficially reduce the risk of electrode fouling from calcium sulfate or magnesium hydroxide precipitates.

The BPMs 203 split water into H⁺ and OFF when electrical DC current is flowing through the power supply 260 (resulting in ionic current flowing through membranes in the BPMED stack 201) and when the potential across the BPMs 203 is above a theoretical water dissociation voltage of 0.83 V. While the BPMED stack 120 is in operation, the solution in the second set of separation chambers 240 becomes acidified and the solution in the first set of separation chambers 230 becomes basified. Ammonia-containing water is fed through the first input conduit 241 to the second set of separation chambers 240. The basic ammonia in the ammonia-containing water reacts with the protons generated by the BPMs 203 to produce ammonium ions (NH₄⁺) as a product in the second set of separation chambers 240. Simultaneously, the ammonium ions NH₄⁺ migrate through the cation exchange membrane 204 bounding one side of the separation chambers 240 and into the first set of separation chambers 230, and reacts there with the hydroxide ion generated by the BPMs 203 to regenerate ammonia (NH₃) as a product in the first set of separation chambers 230. As the result of BPMED and the simultaneous process of ammonia neutralization-ammonium migration-ammonia regeneration, the concentration of ammonia in the feed water decreases (and eventually becomes depleted) in the second set of separation chambers 240 and the concentration of ammonia in the recovery solution increases in the first set of separation chambers 230.

The ammonia-reduced solution in the second set of separation chambers 240 is then routed via the first output conduits 242,122 to the first tank 110, and the ammonia-concentrated solution of the first set of separation chambers 230 is routed via the second output conduits 232,132 to the second tank 130. The output ammonia-reduced water may be recirculated to the BPMED stack 201 until the ammonia concentration of the product water in first tank 110 is reduced to a level below the discharging limit specified in any applicable environmental regulations. The ammonia-concentrated solution (hereinafter interchangeably referred to as the “ammonia-concentrated stream”) may be recirculated to the BPMED stack 201 until the ammonia concentration is increased, and in one embodiment is concentrated to a maximum value possible given the operation conditions. The ammonia-concentrated stream is referred to as being “concentrated” in that its ammonia concentration increases as the BPMED stack 201 is operated, and the ammonia-reduced stream is referred to as being “reduced” in that its ammonia concentration reduces as the BPMED stack 201 is operated.

The routing of the contents of the first and second sets of separation chambers 230,240 may be controlled via suitable valve, conduit, and pump subsystems. For the sake of clarity, these are not shown in FIG. 1 or 2, and are well known to practitioners in the art.

FIG. 3 shows a schematic of a four-compartment embodiment of the BPMED stack 301 of FIG. 1 (this embodiment of the stack 120 is hereinafter interchangeably referred to as a “four-compartment BPMED stack 301”). When using the four-compartment BPMED stack 301, the recovered product may comprise concentrated ammonium salt solution. In FIG. 3, a first input conduit 341 may be connected to the first conduit 121 in FIG. 1 and a second input conduit 331 may be connected to the second input conduit 131 in FIG. 1. The feeding stream from the first tank 110 in FIG. 1 is fed to the four-compartment BPMED stack 301 and its fourth set of separation chambers 340 through the first input conduit 341. The ammonium salt-concentrated stream from the second tank 130 of FIG. 1 is fed to the four-compartment BPMED stack 301 and its first set of separation chambers 330 through the second input conduit 331. Fluid exits the first set of separation chambers 330 via a second output conduit 332 and the second set of separation chambers 340 via a first output conduit 342. The second output conduit 332 may be connected to the second output conduit 132 of FIG. 1 and the first output conduit 342 may be connected to the first output conduit 122 of FIG. 1. An MX salt solution is recirculated through a third set of separation chambers 320 via a third input conduit 321 and a third output conduit 322 into a third tank (not shown in FIG. 1). An aqueous MOH base solution produced by the four-compartment BPMED stack 301 while it is operating is recirculated through a fourth set of separation chambers 310 via a fourth input conduit 311 and a fourth output conduit 312 into a fourth tank (not shown in FIG. 1). Example M⁺ cations are univalent cations such as Na⁺ and K⁺ to prevent membrane fouling. Example Xⁿ⁻ anions may be a univalent (n=1) anion such as Cl⁻, F⁻, and NO₃⁻, a divalent (n=2) anion such as SO₄²⁻, a trivalent (n=3) anion such as PO₄³⁻, and mixtures thereof.

The four-compartment BPMED stack 120 shown in FIG. 3 comprises the four sets of separation chambers 310,320,330,340. Each of the separation chambers is bounded on its cation and anion-facing sides by a different one of three types of ion exchange membranes: bipolar membranes (BPMs) 303, cation exchange membranes (CEMs) 304 and anion exchange membranes (AEMs) 305. In the four-compartment BPMED stack 301, adjacent membranes may cycle from BPM, CEM, AEM, and CEM, forming a membrane stack of the form BPM, CEM, AEM, CEM, BPM, CEM, AEM, CEM, etc. BPMs are impermeable to both cations and anions, and will split water into H⁺ and OH⁻ when a DC current is applied to the four-compartment BPMED stack 301 and the potential across the BPMs is above a theoretical water dissociation voltage of 0.83 V. CEMs are permeable to cations while impermeable to anions. AEMs are permeable to anions while impermeable to cations. Suitable BPMs include, but are not limited to, NEOSEPTA BIPOLAR™ membranes. Suitable CEMs include, but are not limited to NEOSEPTA CMX™ membranes. Suitable AEMs include, but are not limited to NEOSEPTA AMX™ membranes.

On each end of the four-compartment BPMED stack 301 are electrolyte chambers 302. Each of the BPMs 303 is oriented to the electrodes so that its anion-permeable layer faces the stack's 301 anode 306 and its cation-permeable layer faces the stack's 301 cathode 307. An electrolyte solution is contained in an electrolyte tank (not shown) and pumped by an electrolyte pump (not shown) through an electrolyte distribution conduit 352 into electrolyte chambers 302. The electrolyte solution flows back into the electrolyte tank in a closed loop process via an electrolyte return conduit 354. Example electrolytes may include, but are not limited to, aqueous sodium sulfate, aqueous potassium nitrate, and other electrolytes known to those skilled in the art. An electric potential (voltage) is applied to the four-compartment BPMED stack 301 by a direct current power supply 360, which causes an electric current 361 to flow between the anode 306 and cathode 307, which are at opposing ends of the four-compartment BPMED stack 301. Reduction and oxidation reactions of the electrolyte occur at the cathode 307 and anode 306 respectively, converting the DC electrical current into an ionic current.

Adjacent to the electrolyte chambers 302, and separated from them by the cation exchange membranes 304, are two optional rinse solution chambers 314; while shown in FIG. 3, the rinse solution chambers 314 are optional and may be missing from alternative embodiments of the four-compartment stack 301. In the embodiment shown in FIG. 3 the optional rinse solution chambers 314 are separated from the fourth and second sets of separation chambers 310,340 by the BPMs. In other embodiments (not depicted), the optional rinse solution chambers 314 may be separated from the fourth and second sets of chambers 310,340 by AEMs such as NEOSEPTA AMX™ membranes. Rinse solution is supplied via a conduit 362 to the rinse solution chambers 314 and is removed via a rinse solution return conduit 364. The arrangement of optional rinse chambers in the four-compartment BPMED stack 301 prevents scaling cations such as calcium and magnesium from entering the optional rinse solution chambers 314 from the adjacent separation chambers 310,340. The fact that the rinse solution chambers 314 remain free of calcium and magnesium prevents the passage of such calcium and magnesium from the rinse solution chambers 314 to the electrolyte chambers 302. The optional rinse solution chambers 314 beneficially reduce the risk of electrode fouling by calcium sulfate or magnesium hydroxide precipitates.

The BPMs 303 split water into H⁺ and OH⁻ while DC current is applied to the four-compartment BPMED stack 301 and the potential across the BPMs is above a theoretical water dissociation voltage of 0.83 V. The solution in the second set of separation chambers 340 becomes acidified and the solution in the fourth set of separation chambers 310 becomes basified. Ammonia-containing water is fed through the first input conduit 341 to the second set of separation chambers 340. The basic ammonia in this water reacts with the protons generated by the BPMs 303 to produce ammonium ions (NH₄⁺) as a product in the second set of separation chambers 340. Simultaneously, the produced ammonium ions NH₄⁺ migrate through cation exchange membranes 304 into the first set of separation chambers 330 under the driving force resulting from electric potential and ionic current. An MX salt solution is fed to the third set of separation chambers 320. Under the driving force resulting from the applied electric potential and ionic current, X⁻ anions migrate through the anion exchange membranes 305 from the third set of separation chambers 320 and into the first set of separation chambers 330, and M⁺ cations migrate through the cation exchange membranes 304 from the third set of separation chambers 320 into the fourth set of separation chambers 310. X⁻ combines with NH₄⁺ forming NH₄X salt in the first set of separation chambers 330 and M⁺ combines with OFF forming base MOH in the fourth set of separation chambers 310. As the result of the simultaneous process of ammonia neutralization-ammonium migration-ammonium salt generation, the ammonia concentration in the feed water decreases (and eventually depletes) in the second set of separation chambers 340, the ammonium salt concentration in the recovery solution increases in the first set of separation chambers 330, and a base solution is recovered from the fourth set of separation chambers 310.

The ammonia-reduced water from the second set of separation chambers 340 is routed via the first output conduits 342,122 to the first tank 110 and the ammonium salt-concentrated solution from the first set of separation chambers 330 is routed via the second output conduit 332,132 to the second tank 130. The output ammonia-reduced water may be recirculated to the four-compartment BPMED stack 301 until the ammonia concentration of the product water in the first tank 110 is reduced below the discharging limit as specified by any applicable environmental regulations. The ammonium salt-concentrated solution may be recirculated to the four-compartment BPMED stack 301 until the ammonium salt concentration is concentrated to a suitable concentration and, in one embodiment, to a maximum value possible under the operating conditions. The MX-desalinated solution from the second set of separation chambers 320 flows via the third output conduit 322 to a third tank (not shown in FIG. 1) and may be recirculated to the four-compartment BPMED stack 301. MX salt is compensated occasionally in the third tank to keep a sufficiently high ion content to maintain ionic current flowing in the third set of separation chambers 320. The aqueous MOH base solution from the fourth set of separation chambers 310 flows via the fourth output conduit 312 to a fourth tank (not shown in FIG. 1) and may be recirculated to the four-compartment BPMED stack 301 to increase its concentration to a level suitable for sale or other applications. The ammonium salt-concentrated stream is referred to as being “concentrated” in that its ammonium salt concentration increases as the BPMED stack 301 is operated, and the ammonia-reduced stream is referred to as being “reduced” in that its ammonia concentration reduces as the BPMED stack 301 is operated.

The routing of the contents of the four sets of separation chambers 310,320,330,340 may be controlled via suitable valve, conduit, and pump subsystems. For the sake of clarity, these are not shown in FIG. 1 or 3, and are well known to practitioners in the art.

It is contemplated that any part of any aspect or embodiment discussed in this specification can be implemented or combined with any part of any other aspect or embodiment discussed in this specification.

For the sake of convenience, the exemplary embodiments above are described as various interconnected functional blocks. This is not necessary, however, and there may be cases where these functional blocks are equivalently aggregated into a single logic device, program or operation with unclear boundaries. In any event, the functional blocks can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A process for removing ammonia from an aqueous ammonia solution, the process comprising:
(a) flowing a first aqueous solution and the ammonia solution respectively through a first and a second separation chamber of a bipolar membrane electrodialysis (“BPMED”) stack, wherein the first separation chamber is bounded on an anodic side by a cation exchange membrane and wherein the second separation chamber is bounded on a cathodic side by the cation exchange membrane and on an anodic side by a bipolar membrane, the bipolar membrane comprising an anion-permeable layer and a cation-permeable layer respectively oriented to face an anode and a cathode of the BPMED stack; and
(b) applying a voltage across the BPMED stack that causes a direct current to be passed across the bipolar membrane thereby causing the bipolar membrane to dissociate water into protons and hydroxide ions, wherein:
(i) the protons migrate into the second separation chamber; and
(ii) the protons react with ammonia comprising the ammonia solution in the second separation chamber to form ammonium ions that migrate from the second separation chamber to the first separation chamber across the cation exchange membrane.

2. The process of claim 1 further comprising returning the ammonia solution exiting the second separation chamber (“ammonia-reduced solution”) to the second separation chamber to remove more of the ammonia therefrom.

3. The process of claim 1 wherein the first separation chamber is bounded on a cathodic side by an additional bipolar membrane comprising an anion-permeable layer and a cation-permeable layer respectively oriented to face the anode and the cathode, and wherein a direct current is also passed across the additional bipolar membrane thereby causing the bipolar membrane to dissociate water into protons and hydroxide ions, wherein the hydroxide ions migrate into the first separation chamber and react with the ammonium ions react to generate ammonia in the first separation chamber.

4. The process of claim 3 further comprising returning the solution that exits the first separation chamber (“concentrated ammonia solution”) to the first separation chamber to further concentrate the ammonia therein.

5. The process of claim 4 further comprising recovering gaseous ammonia from the concentrated ammonia solution.

6. The process of claim 1 wherein the first separation chamber is bounded on a cathodic side by an anion exchange membrane and the BPMED stack further comprises:
(a) a third separation chamber bounded on an anodic side by the anion exchange membrane and on a cathodic side by an additional cation exchange membrane; and
(b) a fourth separation chamber bounded on an anodic side by the additional cation exchange membrane and on a cathodic side by an additional bipolar membrane comprising an anion-permeable layer and a cation-permeable layer respectively oriented to face the anode and the cathode,
wherein the process further comprises:
(c) flowing an aqueous salt solution and an aqueous base solution respectively through the third and fourth separation chambers, wherein the aqueous salt solution comprises M⁺ cations and Xⁿ⁻ anions and the aqueous base solution comprises the M⁺ cations and hydroxide ions,
wherein a direct current is passed across the additional bipolar membrane causing the bipolar membrane to dissociate water into protons and hydroxide ions, wherein the hydroxide ions migrate into the fourth separation chamber and wherein the M⁺ cations migrate from the third separation chamber to the fourth separation chamber across the additional cation exchange membrane and the Xⁿ⁻ anions migrate from the third separation chamber to the first separation chamber across the anion exchange membrane, the ammonium and the Xⁿ⁻ anions comprising an ammonium salt solution in the first separation chamber.

7. The process of claim 6 further comprising returning the ammonium salt solution that exits the first separation chamber to the first separation chamber to increase concentration of the ammonium salt solution.

8. The process of claim 6 further comprising returning the aqueous base solution that exits the fourth separation chamber to the fourth separation chamber to increase concentration of the base solution.

9. The process of claim 6 wherein some of the aqueous salt solution exits the third separation chamber, and further comprising returning the aqueous salt solution that exits the third separation chamber to the third separation chamber for reuse.

10. The process of claim 6 further comprising recovering solid ammonium salt from the ammonium salt solution.

11. A system for removing ammonia from an aqueous ammonia solution, the system comprising:
(a) a bipolar membrane electrodialysis (“BPMED”) stack for receiving a first aqueous solution and the ammonia solution, the BPMED configured to output:
(i) an ammonia-reduced solution having a lower concentration of ammonia than the ammonia solution and one of:
(1) an ammonium salt solution; and
(2) a concentrated ammonia solution having a higher concentration of ammonia than the ammonia-reduced solution; and
(b) a purification subsystem fluidly coupled to the BPMED stack to receive the ammonium salt solution or the concentrated ammonia solution and configured to output solid ammonium salt or ammonia gas.

12. The system of claim 11 wherein the BPMED stack is configured to output the ammonium salt solution and the purification subsystem is configured to output the solid ammonium salt.

13. The system of claim 12 wherein the BPMED stack comprises a first and a second separation chamber, wherein the second separation chamber is bounded on a cathodic side by a cation exchange membrane and on an anodic side by a bipolar membrane, the bipolar membrane comprising on an anodic side an anion-permeable layer and on a cathodic side a cation-permeable layer, and wherein the first separation chamber is bounded on an anodic side by the cation exchange membrane and on a cathodic side by an additional bipolar membrane comprising on an anodic side an anion-permeable layer and on a cathodic side a cation-permeable layer.

14. The system of claim 12 wherein the purification subsystem comprises a degassing system.

15. The system of claim 14 wherein the degassing system uses any one or more of a thermal process, vacuum stripping, streaming stripping, and membrane degassing.

16. The system of claim 11 wherein the BPMED stack is configured to output the concentrated ammonia solution and the purification subsystem is configured to output the ammonia gas.

17. The system of claim 16 wherein the BPMED stack comprises a first, a second, a third, and a fourth separation chamber, wherein the second separation chamber is bounded on a cathodic side by a cation exchange membrane and on an anodic side by a bipolar membrane, the bipolar membrane comprising on an anodic side an anion-permeable layer and on a cathodic side a cation-permeable layer, wherein the first separation chamber is bounded on an anodic side by the cation exchange membrane and on a cathodic side by an anion exchange membrane, wherein the third separation chamber is bounded on an anodic side by the anion exchange membrane and on a cathodic side by an additional cation exchange membrane, and wherein the fourth separation chamber is bounded on an anodic side by the additional cation exchange membrane and on a cathodic side by an additional bipolar membrane comprising on an anodic side an anion-permeable layer and on a cathodic side a cation-permeable layer.

18. The system of claim 16 wherein the purification subsystem comprises a solid purification system.

19. The system of claim 18 wherein the solid purification subsystem comprises a crystallizer or a thermal evaporator.
